(19) United States
(12) Patent Application Publication
(10) Pub. No.: US 2026/0368469 A1
(43) Pub. Date: Nov. 19, 2026

(54) APPARATUS AND SYSTEM FOR TRACKING SEEDS

(71) Applicant: PIONEER HI-BRED INTERNATIONAL, INC., JOHNSTON, IA (US)

(72) Inventors: JOE HYNEK, DES MOINES, IA (US); PATRICK LEER, URBANDALE, IA (US); JACOB DEAN TANK, JOHNSTON, IA (US); TIMOTHY WILSON, WEST DES MOINES, IA (US)

(73) Assignee: PIONEER HI-BRED INTERNATIONAL, INC., JOHNSTON, IA (US)

(21) Appl. No.: 19/133,871

(22) PCT Filed: Dec. 1, 2023
(86) PCT No.: PCT/US2023/082030

§ 371 Date: May 29, 2025

Related U.S. Application Data
(60) Provisional application No. 63/387,472, filed on Dec. 14, 2022.

(51) Int. Cl. G06K 19/07; A01C 7/08; G06Q 10/0833

(52) U.S. Cl. CPC G06K 19/0723; A01C 7/081; G06Q 10/0833

(57) ABSTRACT

A system and apparatus for dispensing an electronic tracking device into a container of seeds may include an electronic tracking device hopper that contains a plurality of electronic tracking devices. The electronic tracking devices may be RFID tags that have a seed-like shape. The system further includes a singulator configured to separate an individual RFID tag from the RFID tag hopper, an RFID tag reader configured to read a factory setting from the individual RFID tag, an RFID tag writer configured to encode a predetermined set of data on the individual RFID tag. The system may dispense an encoded individual RFID tag into a container that includes a plurality of seeds, where the predetermined set of data encoded on the individual RFID tag contains information about the seeds in the container.

### CROSS-REFERENCE TO RELATED APPLICATION

This application claims priority to and benefit of U.S. Application No. 63/387,472 filed on Dec. 14, 2022, and PCT/US2023/082030 filed on Jan. 12, 2023, which are each incorporated herein by reference in its entirety.

### TECHNICAL FIELD

This disclosure relates to an apparatus and system to seed dispensing and seed planting. In particular, an apparatus and system to dispense one or more electronic tracking devices intermingled with seeds in a container to gather seed planting data and optimize seed planting operations.

### BACKGROUND

When harvesting grain or other crops, identifying and understanding the exact species of the crops is important. Knowing the location and exact type of seeds when they are planted can help to identify the crops at harvest. Manually tracking and retrieving this data can be time consuming and may have problems with accuracy. A system to assist in tracking and identifying seeds prior to planting can make this identification process easier.

### BRIEF SUMMARY

The following presents a general summary of aspects of the invention in order to provide a basic understanding of the invention. This summary is not an extensive overview of the invention. It is not intended to identify key or critical elements of the invention or to delineate the scope of the invention. The following summary merely presents some concepts of the invention in a general form as a prelude to the more detailed description provided below.

Aspects of this disclosure may relate to a system for filling seeds into a container, where the system comprises: (a) a bulk seed hopper containing a plurality of seeds; (b) an RFID tag hopper containing a plurality of RFID tags having a seed-like shape; (c) a singulator configured to separate an individual RFID tag of the plurality of RFID tags from the RFID tag hopper; (d) an RFID tag reader and writer configured to read a factory setting from the individual RFID tag and encode a predetermined set of data on the individual RFID tag. The system may operate such that a portion of the plurality of seeds are dispensed from the bulk seed hopper into the container, and the individual RFID tag is dispensed into the container. In addition, the system may include a processor to determine if the individual RFID tag is operational based off information from the RFID tag reader reading of the factory setting, where when the processor determines the individual RFID tag is inoperative, the individual RFID tag is discarded. The static data presented in the factory setting of the individual RFID tag may be associated with an internal Batch ID number is be used for internal tracking and traceability to manufacturer product parameters of which seed batch was planted in a read location. The system may further comprise a drop gate that holds the individual RFID tag after the predetermined set of data is written to the individual RFID tag, where the processor sends a signal to the drop gate to dispense the individual RFID tag into the same container. The singulator may also include a servo motor, a vacuum, and a seed plate. Optionally, the singulator may include a vibratory feeder and a staging system. In some examples, the singulator may include a vibratory feeder. The predetermined set of data encoded on the individual RFID tag may include information related to the seeds filled in the container. The predetermined set of data may include the product name of the seeds filled in the container. Static data presented in the factory setting of the individual RFID tag may be associated with an internal Batch ID number that is different than the product name. The system may also comprise a planting mechanism that plants the individual RFID tag, and a second RFID tag reader thereby detecting and recording an identity of the container of seeds being planted in that location. The RFID tags with the seed-like shape may use a material that is decomposable.

Other aspects of this disclosure may relate to a machine for dispensing seed-like shaped RFID tags comprising: (a) an RFID tag hopper configured to store a plurality of RFID tags, where each RFID tag of the plurality of RFID tags may have a seed-like shape; (b) a singulator connected to the RFID tag hopper, where the singulator separates an individual RFID tag of the plurality of RFID tags from the RFID tag hopper; (c) an encoding chamber connected to the singulator, where an RFID tag writer encodes a predetermined set of data to the individual RFID tag; and (d) a drop gate connected to the encoding chamber to hold the individual RFID tag until instructed by a processor to open the drop gate and release the individual RFID tag into a container of seeds. The machine may further comprise an RFID tag reader positioned near the singulator to read a factory setting from the individual RFID tag, and a discard chute located between the RFID tag reader and the encoding chamber. Additionally, the machine may further comprise a non-transitory computer readable medium storing computer readable instructions that, when executed by the processor, causes the processor to at least: (a) receive a user input for the predetermined set of data; (b) instruct the RFID tag writer to encode the predetermined set of data to the individual RFID tag; (c) instruct the drop gate to dispense the individual RFID tag into the container; and (d) determine a time interval or volumetric or weight based bulk dispensing to open and close the drop gate to control a number of RFID tags dispensed into the container of seeds. In some examples, the RFID tag hopper may be positioned above the singulator and the drop gate. Also, the singulator may include a vacuum and a servo motor, along with a seed plate to individually select the individual RFID tag. Optionally, the singulator may include a vibratory feeder and a staging system.

Still other aspects of this disclosure may relate to a method for dispensing seed-shaped RFID tags comprising: (a) loading a plurality of seed-shaped RFID tags into an RFID tag hopper; (b) extracting an individual RFID tag from the RFID tag hopper; (c) verifying the extracted individual RFID tag is operational; (d) discarding the extracted individual RFID tag if it is inoperable; (e) encoding a predetermined set of data onto the extracted individual RFID tag; (f) moving the extracted individual RFID tag to a drop gate; and (g) opening the drop gate to dispense the extracted individual RFID tag into a container of seeds. The predetermined set of data may include information related to the seeds in the container. In addition, the method may further comprise using a planting mechanism that plants the individual RFID tag and a second RFID tag reader to detect and record an identity of the container of seeds being planted in that location. An antenna of the RFID tag reader may be located in a position on the planting mechanism that reads the individual RFID tag at a point where the individual RFID tag is located in a portion of the planting mechanism where the seeds aggregate prior to being singulated for planting. In some examples, the predetermined set of data read from the RFID tag is transmitted directly to an ISOBUS of the planting mechanism.

### DESCRIPTION OF THE DRAWINGS

To allow for a better understanding of the present disclosure, it will now be described by way of example, with reference to the accompanying drawings in which:

FIG. 1 illustrates a schematic diagram for a system to dispense an electronic tracking device into a container of seeds, in accordance with aspects of the disclosure;

FIG. 2 illustrates a perspective view of an exemplary apparatus for dispensing an electronic tracking device and seeds into a container, in accordance with aspects of the disclosure;

FIG. 3 illustrates a perspective view of the exemplary apparatus of FIG. 2 for dispensing an electronic tracking device into a container of seeds, in accordance with aspects of the disclosure;

FIG. 4 illustrates a perspective view of the exemplary apparatus of FIG. 2 for dispensing an electronic tracking device and seeds into a container, in accordance with aspects of the disclosure;

FIG. 5 illustrates a front view of the exemplary apparatus of FIG. 2 for dispensing an electronic tracking device and seeds into a container, in accordance with aspects of the disclosure;

FIG. 6 illustrates a rear view of the exemplary apparatus of FIG. 2 for dispensing an electronic tracking device and seeds into a container, in accordance with aspects of the disclosure;

FIG. 7 illustrates a flowchart for a method to dispense an electronic tracking device into a container of seeds, in accordance with aspects of the disclosure;

FIGS. 8 and 9 illustrate exemplary electronic tracking devices that are dispensed into a container of seeds, in accordance with aspects of the disclosure;

FIG. 10 illustrates a perspective view of exemplary electronic tracking devices mixed with seeds, in accordance with aspects of the disclosure;

FIG. 11 illustrates a perspective view of an exemplary planting mechanism with an electronic tracking device reader, in accordance with aspects of the disclosure;

FIG. 12 illustrates a side cross-sectional view of a seed metering device of the planting mechanism, in accordance with aspects of the disclosure; and

FIG. 13 illustrates a perspective view of an alternate an exemplary apparatus for dispensing an electronic tracking device and seeds into a container, in accordance with aspects of the disclosure.

### DETAILED DESCRIPTION

While this invention is susceptible of embodiments in many different forms, there are shown in the drawings and will herein be described in detail example embodiments of the invention with the understanding that the present disclosure is to be considered as an exemplification of the principles of the invention and is not intended to limit the broad aspect of the invention to the embodiments illustrated. In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention.

Also, while the terms “front,” “side,” “rear,” “above”, “below”, and the like may be used in this specification to describe various example features and elements of the invention, these terms are used herein as a matter of convenience, e.g., based on the example orientations shown in the figures or the orientation during typical use. Nothing in this specification should be construed as requiring a specific three-dimensional orientation of structures in order to fall within the scope of this invention. Also, the reader is advised that the attached drawings are not necessarily drawn to scale.

The following terms are used in this specification, and unless otherwise noted or clear from the context, these terms have the meanings provided below.

“Plurality,” as used herein, indicates any number greater than one, either disjunctively or conjunctively, as necessary, up to an infinite number.

In general, this disclosure relates to a system for dispensing electronic tracking devices into containers of seeds and also a method of tracking the electronic tracking devices such that the characteristics of the seeds and their location when planted may be known and tracked such that the identity of crops grown from the seeds can be easily identified at harvest. The electronic tracking devices may have a seed-like shape and may be a radio frequency identification (RFID) tag (i.e. an RFID tag) with an antenna that is able to transmit stored information to an electronic tracking device reader, (i.e. an RFID tag reader) and also able to receive and store information encoded on it by an electronic tracking device writer (i.e. an RFID tag writer).

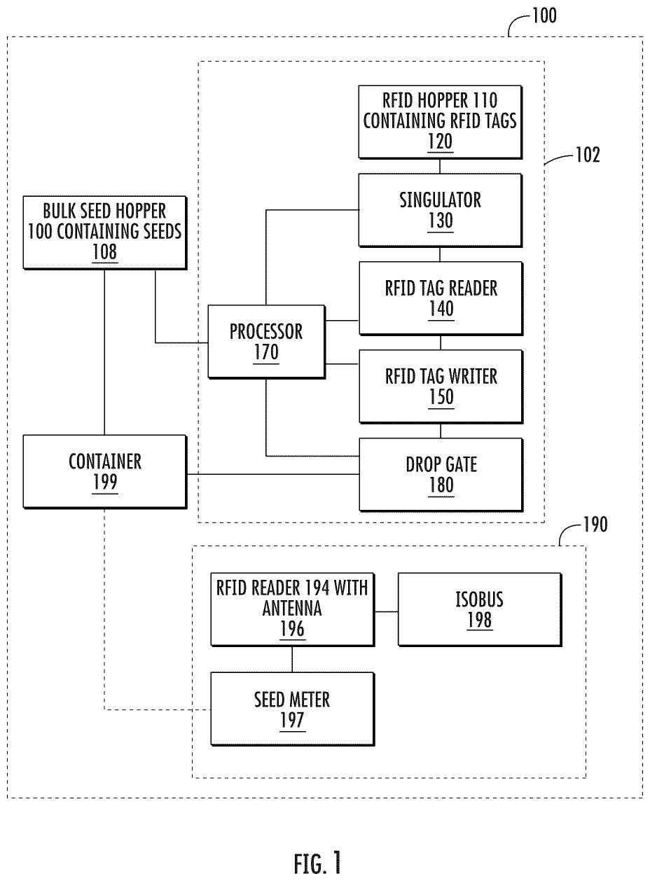

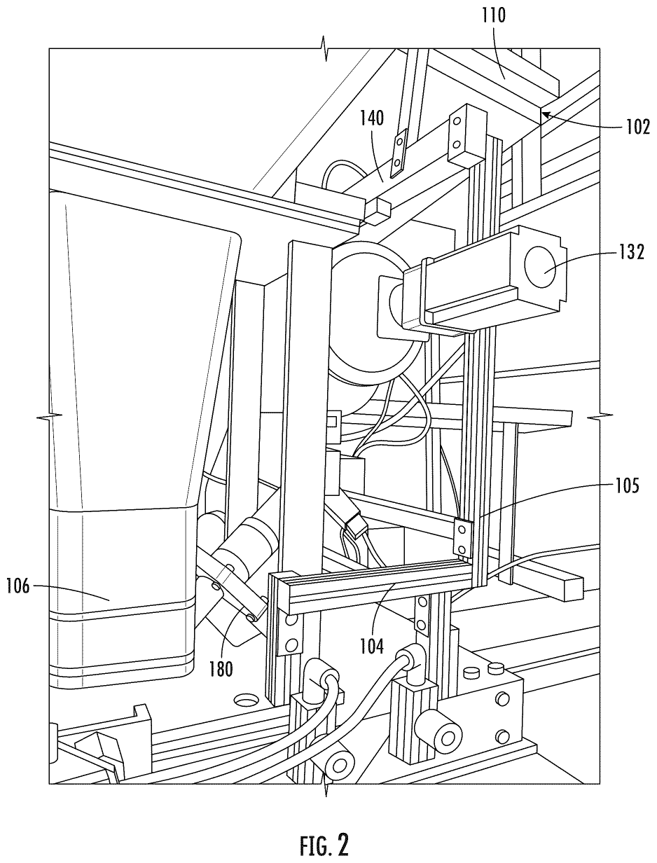

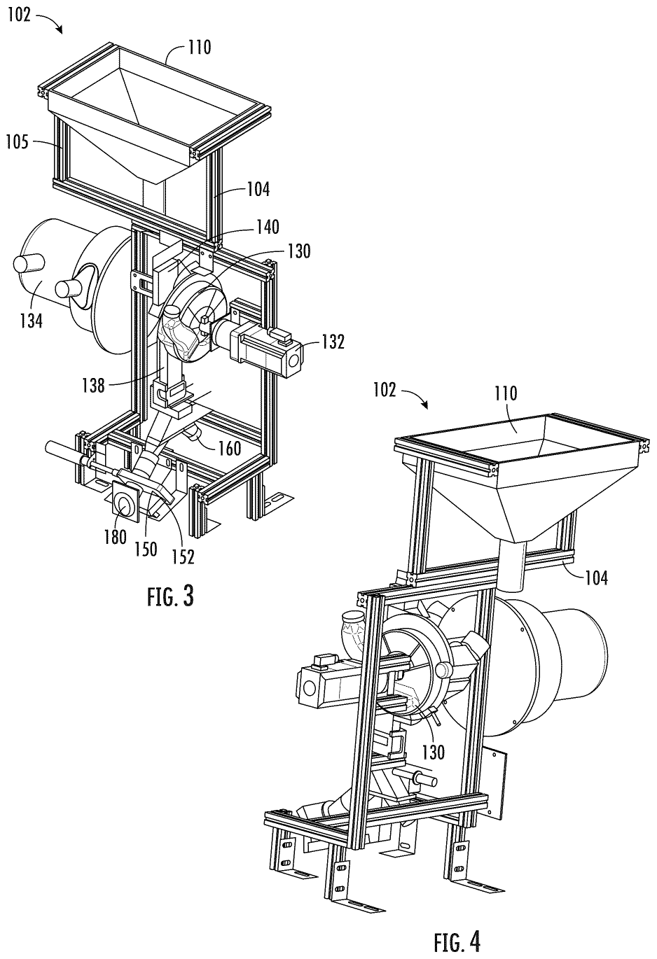

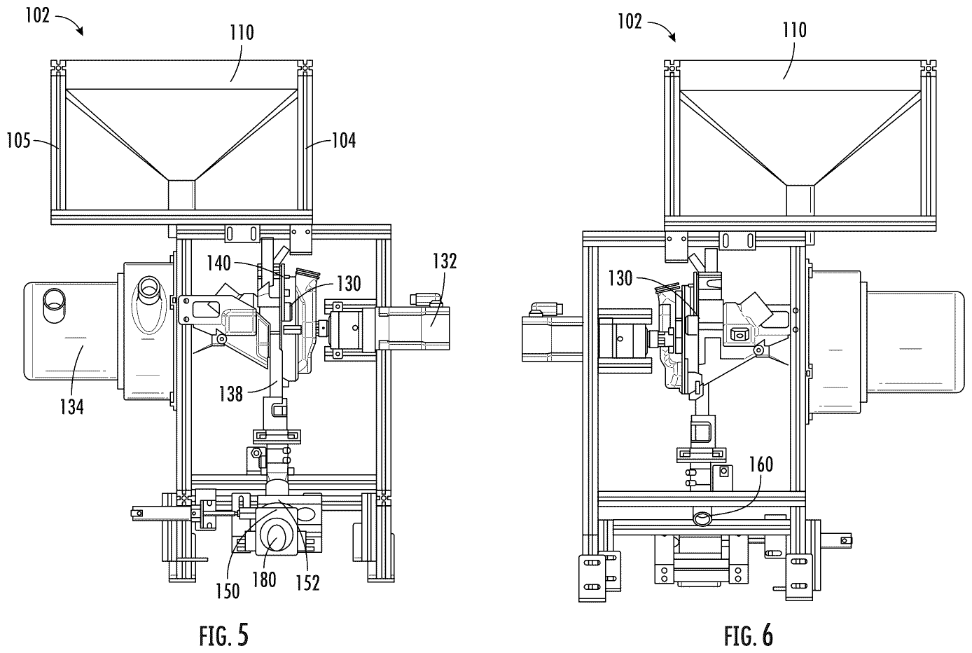

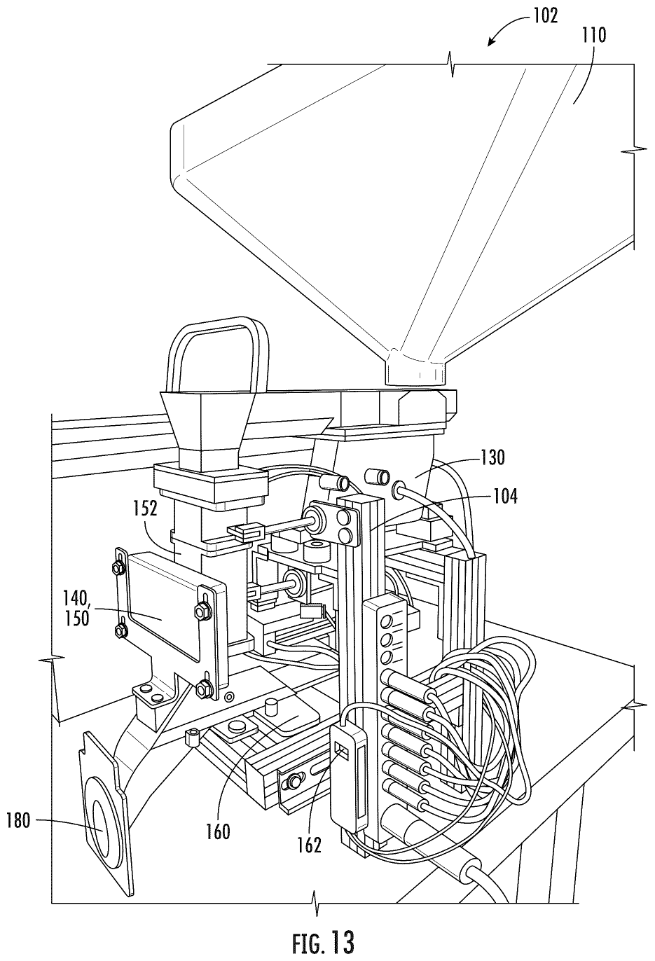

FIG. 1 illustrates a schematic of a system 100 for dispensing or filling seeds into a container. The system may comprise an RFID tag hopper 110 that contains a plurality of RFID tags 120, a singulator 130 that is configured to separate an individual RFID tag 120 from the RFID tag hopper 110, an RFID tag reader 140 configured to read a factory setting from the individual RFID tag 120 separated by the singulator 130, and an RFID tag writer 150 configured to encode a predetermined set of data on the individual RFID tag 120 separated by the singulator 130. In some examples, such as the machine 102 shown in FIGS. 2-6, the RFID tag reader 140 and the RFID tag writer 150 may be separate devices in different locations on the machine 102. Alternatively, as shown in the machine 102 of FIG. 13, the RFID tag reader 140 and the RFID tag writer 150 may be located in a single device. A processor 170 may help to coordinate the movement of the RFID tag 120 through the system and also determine how many RFID tags 120 may be dispensed in each container (i.e. one or more RFID tags 120 may be dispensed in each container 199 depending on the size of the container 199, such that one, two, three, or more than three RFID tags 120 may be dispensed in each container 199). The system may further comprise a bulk seed hopper 106 that contains a plurality of seeds 108. The RFID tags 120 may use a decomposable material and have a seed-like shape such that they may have a similar size and shape as the seeds 108 that are in the bulk seed hopper 106. The plurality of seeds 108, or a portion of the plurality of seeds 108 from the bulk seed hopper 106 may be dispensed into the container 199. The individual RFID tag 120 may be held by a drop gate 180 that holds the individual RFID tag 120 after the predetermined set of data is written to the individual RFID tag 120 until the encoded RFID tag 120 is dispensed into the container 199 with the plurality of seeds 108 that are dispensed from the bulk seed hopper 106 into the container 199. The predetermined set of data includes information related to the seeds 108 filled in the container 199. The seeds 108 along with the encoded RFID tag 120 may be planted by a planting mechanism 190 that includes an RFID tag reader 194, where the RFID tag reader 194 on the planting mechanism 190 to detect and record the identity of the container 199 of seeds 108 being planted in that location.

The system 100 may also include a processor 170 that determines if the individual RFID tag 120 is operational based off the reading of the factory setting. In addition, the processor 170 determines the individual RFID tag is inoperative, the individual RFID tag is discarded. In some examples, the processor 170 may send a signal to the drop gate 180 to dispense the individual RFID tag 120 into the container 199 to control the timing of the release of the encoded RFID tags 120 into the container 199. The processor 170 may be a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The one or more implementations described throughout this disclosure may utilize logical blocks, modules, and circuits that may be implemented or performed with a processor.

The processor 170 may be used to implement various aspects and features described herein. As such, the processor 170 may be configured to perform any desired operation to control and operate the dispensing of the RFID tags 120. Further, it will be appreciated that the processor 170 may execute multiple calculations, in parallel or serial, at a very high throughput frequency. As such, processor 170 may be configured to execute hundreds of thousands, millions, or billions or more calculations per second. The processor 170 may include a processing unit and system memory to store and execute software instructions. In some examples, the processor 170 may receive and transmit data regarding the seeds 108 and/or RFID tags 120 to one or more remote computing devices. This data may include receiving the information to encode onto the seed-shaped RFID tags 120 and storing the data associated with each individual seed-shaped RFID tag 120.

FIGS. 2-6 illustrate a machine or apparatus 102 used to dispense the RFID tags 120 into the container 199 of seeds 108 of the system 100. The machine 102 may include a frame 104 with an RFID tag hopper 110 arranged an upper portion of the frame 104, where the RFID tag hopper 110 stores a plurality of RFID tags 120. The frame 104 may comprise a plurality of vertically and horizontally arranged beams 105. The singulator 130 may be connected to the RFID tag hopper 110 and located below the RFID tag hopper 110 such that gravity may help feed the RFID tags 120 from the RFID tag hopper 110 to the singulator 130. An RFID tag reader 140 may be positioned near or adjacent to the singulator 130, so the RFID tag reader 140 can read a factory setting on each individual RFID tag 120 that is extracted by the singulator 130. The individual RFID tags 120 may leave the singulator 130 via a drop tube 138 towards the encoding chamber 152. If any RFID tags 120 are determined to be inoperable when read by the RFID tag reader 140, the inoperable RFID tag 120 may be separated and sent to a discard chute 160 located between the RFID tag reader 140 and the encoding chamber 152. Alternatively, as shown in FIG. 13, the exemplary apparatus 102 may the singulator 130 may be a vibratory feeder to singulate the RFID tags 120 and includes a staging system with a gated chamber to hold the singulated RFID tags 120 prior to their reading and encoding. If the RFID tag 120 is determined to be operable, the RFID tag 120 may pass to an encoding chamber 152 connected to and located below the singulator 130. A diverter gate device, a flapper structure, or other means known to one skilled art may be used to move the inoperable RFID tags 120 to the discard chute 160, while allowing the operable RFID tags 120 to move to the encoding chamber 152. In some examples, a sensor 162 may be located near the discard chute 160 to verify that an inoperable RFID tag was removed. The sensor 162 may be a break beam sensor as shown in FIG. 13 or other sensor known to one skilled in the art. The encoding chamber 152 may include the RFID tag writer 150 to encode a predetermined set of data to the selected individual RFID tag 120. A drop gate 180 may be connected to and located below the encoding chamber 152, where the drop gate 180 comprises a door or gate that is configured to open and close upon receiving the proper signal. The drop gate 180 may hold the selected encoded RFID tag 120 until the drop gate 180 opens to release the selected encoded RFID tag 120 into the container 199 of seeds 108.

The singulator 130 may be a seed metering device to singulate and transfer seeds from the RFID tag hopper 110 past the RFID tag reader 140 to the encoding chamber 152. In the illustrated example, the singulator 130 may be a vacuum-type seed metering device that includes a servo motor 132 that rotates a seed plate located within the singulator 130 and a vacuum 134. The seed plate may be configured to rotate within the singulator 130 to pick up individual RFID tags 120 in apertures sized to hold an individual RFID tags 120. The apertures may be connected to the vacuum 134 that holds the RFID tags 120 to each aperture. When the rotating seed plate nears the drop tube 138, the rotating seed plate may lose the force from the vacuum 134 holding the RFID tag 120 to its corresponding aperture to allow the RFID tag 120 to be released into the drop tube 138 and travel to the encoding chamber 152. Alternatively, the singulator 130 may be also cone-type seed metering device. An exemplary singulator 130 may be similar to the seed metering device described in U.S. patent application Ser. No. 12/855,430 filed on Aug. 14, 2009, now U.S. Pat. No. 8,473,168, which is incorporated by reference in its entirety.

The container 199 may comprise a variety of storing devices. For example, the container 199 may comprise bags, box, probox, bulk bins, hoppers, combine harvesters, weigh wagons, or other means known to one skilled in the art to move or store seeds. While the embodiments show an RFID tag 120 in the approximate size, shape and weight of a corn seed, different RFID tags that function in planting mechanisms with the corresponding type of crop seed they are tracking may also be used. Crops that are particularly suited to be tracked using the embodiments described herein include, but are not limited to, relatively large seeded row crops such as corn, soybean, sunflower, dry bean, field pea, potato, sugar beet, and safflower. Smaller seeded crops such as wheat, rice, buckwheat, flax and cotton may also be tracked with corresponding crop size, shape and weight RFID tags.

The system 100 may also include a processor 170 that determines if the individual RFID tag 120 is operational based off the reading of the factory setting. In addition, the processor 170 determines the individual RFID tag is inoperative, the individual RFID tag is discarded. In some examples, the processor 170 may send a signal to the drop gate 180 to dispense the individual RFID tag 120 into the container 199 to control the timing of the release of the encoded RFID tags 120 into the container 199. The processor 170 may be a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The one or more implementations described throughout this disclosure may utilize logical blocks, modules, and circuits that may be implemented or performed with a processor.

The processor 170 may be used to implement various aspects and features described herein. As such, the processor 170 may be configured to perform any desired operation to control and operate the dispensing of the RFID tags 120. Further, it will be appreciated that the processor 170 may execute multiple calculations, in parallel or serial, at a very high throughput frequency. As such, processor 170 may be configured to execute hundreds of thousands, millions, or billions or more calculations per second. The processor 170 may include a processing unit and system memory to store and execute software instructions. In some examples, the processor 170 may receive and transmit data regarding the seeds 108 and/or RFID tags 120 to one or more remote computing devices. This data may include receiving the information to encode onto the seed-shaped RFID tags 120 and storing the data associated with each individual seed-shaped RFID tag 120.

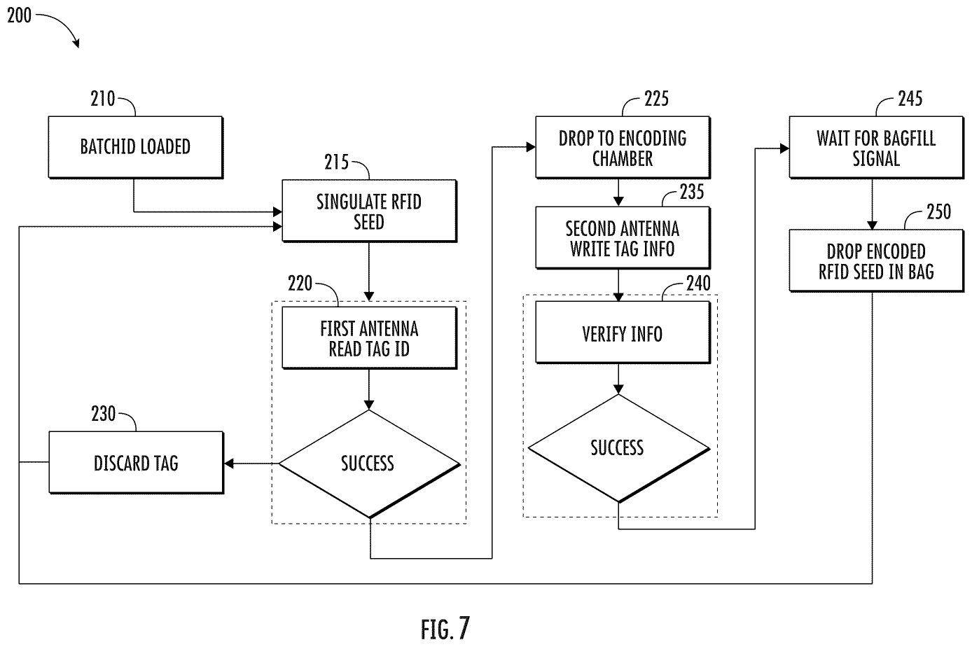

In general, the system 100 may dispense the RFID tags 120 into the container 199 of seeds using a method 200 described below and shown in FIG. 7. First, the batch ID and seed information along with the rate or desired concentration of RFID tags 120 (i.e. the number of RFID tags 120 per container 199) may be loaded to the system 100 and/or processor 170 via a database or user input (210). Next, the RFID tags 120 may be extracted or isolated via the singulator 130 (215), and the RFID tag reader 140 on the machine 102 may read the RFID tag ID and factory information. If the RFID tag reader 140 and/or processor 170 verifies that the isolated RFID tag 120 is operable or inoperable (220). If the RFID tag 120 is determined to by operable, the RFID tag 120 is moved to the encoding chamber 152 (225). But, if the RFID tag reader 140 and/or processor 170 verifies that the isolated RFID tag 120 is inoperable, the inoperable RFID tag 120 is sent to the discard chute 160 to be removed from the system 100 (230). Once in the encoding chamber 152, the processor 170 may instruct the RFID tag writer 150 to encode the predetermined set of data onto the extracted individual RFID tag 120, and in some examples, the RFID tag writer 150 may also read back the encoded information to verify the RFID tag 120 is operable and that the encoded information is easily retrieved (235). Once the encoded information is verified (240), the extracted individual RFID tag 120 is moved to the drop gate 180, where the processor 170 waits to receive a signal that the seeds 108 are dispensed into the container 199 (245). Upon receiving a signal that the seeds 108 are dispensed in the container 199, the processor 170 may send a signal to the drop gate 180 instructing the drop gate 180 to open and release the encoded extracted individual RFID tag 120 into the container 199 of seeds 108 (250). Thus, the processor 170 may determine the time interval to open and close the drop gate 180 to control the number of RFID tags 120 dispensed into each container 199 of seeds 108. Optionally, the processor 170 may or volumetric or weight based bulk dispensing system to determine when to open and close the drop gate 180 to control the number of RFID tags 120 dispensed into each container 199 of seeds 108.

As discussed above, the RFID tags 120 may be encoded with a predetermined set of data. In some instances, the predetermined set of data may include the Batch ID of the seeds 108 along with the Variety and/or Hybrid name of the seeds 108. In some examples, the static data presented in the factory setting of the RFID tag 120 may be associated with the internal Batch ID number may be used for internal tracking of which seed batch was planted in a read location or tracked location. In addition, the predetermined set of data may include a manufacturer's product name that is readable to OEM's with an RFID reader. In some embodiments, a second non-seed like standard RFID tag may be affixed to the exterior of the container 199 and/or a pallet of containers 199, said second RFID tag comprising the same encoded information as the information encoded on the seed like shaped RFID tag 120 located within the container 199. The second RFID tag affixed to the container 199 and/or pallet can be utilized to more easily track inventory and/or as a redundant source of information, while the first RFID tag is utilized primarily to track information about the seed batch in the container 199, which information can automatically be read as the seed is being planted.

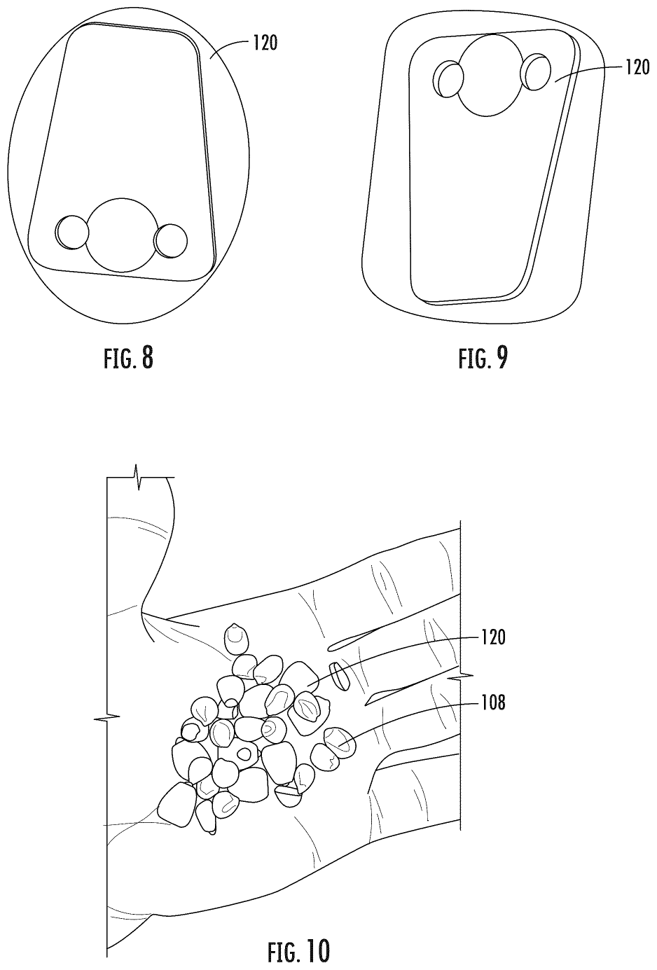

The seed-shaped RFID tags 120 are illustrated in FIGS. 8 and 9. The shape may be arranged to enable optimal plantability. The shaping may help to maximize the adherence to the vacuum plate of the singulator 130 or other seed metering device the RFID tag 120 may encounter during the planting process. In addition, the RFID tags 120 may include a similar density to the seed 108 being dispensed and may have a maximize the antenna size to enable the RFID tag reader 140 to easily read and recognize the tag 120. The RFID tags 120 may also be decomposable and to be easily mixed with the seeds 108 being dispensed as shown in the mixture of seeds 108 and tags 120 in FIG. 10.

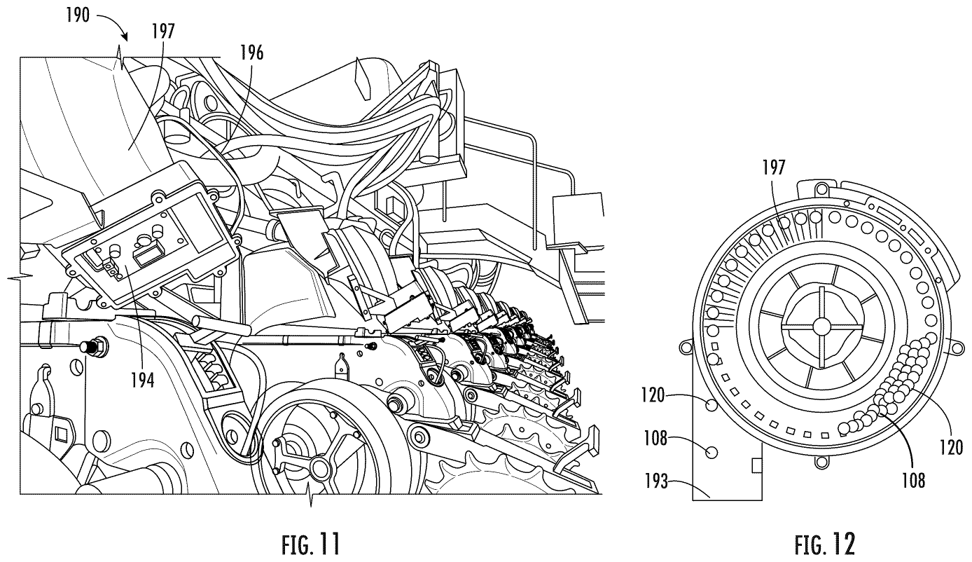

Once the container 199 of seeds 108 and the embedded RFID tag 120 are ready for planting, the planting mechanism 190 may include an RFID tag reader 194 with an antenna 196 that can detect and record the identity of the encoded RFID tags 120 intermixed with the seeds 108 from the container 199 of seeds 108 that is being planted as shown in FIG. 11. The RFID tag reader 194 and its antenna 196 may be located in an optimum location of the seed-metering device 197 on the planting mechanism 190 to provide a maximum amount of time for the RFID tag reader 194 to read the information on the RFID tags 120 when the seeds 108 may pool in a portion of the seed-metering device 197 or as they leave the seed-metering device 197 at the exit 193. The planting mechanism 190 may include a GPS system to mark the location of the planting mechanism 190. The location and encoded information of the planted seeds 108 and RFID tags 120 can be recoded and sent directly to the ISOBUS 198 of the planting mechanism 190 if a cellular or network connection is not available. Optionally or in addition to the information being sent to the ISOBUS 198, the location and encoded information of the planted seeds 108 and RFID tags 120 may be sent via a cellular or network connection to a remote computer or database for further use. The RFID tag reader 194 and its associated antenna 196 may be located in a position of the planting mechanism 190 to read the RFID tag 120 at the point where the RFID tag 120 is located in a portion of the planting mechanism 190 where the seeds 108 aggregate prior to being singulated for planting, such as the seed-metering device 197 shown in FIG. 12.

The various embodiments described herein enable a dispensing of a seed-shaped RFID tag 120 into a container of seeds 108. It is also understood that the systems, methods, and machines described herein may be constructed with similar structural and functional elements having different configurations, including different ornamental appearances. Still other benefits may be recognized by those skilled in the art. Accordingly, while the specific embodiments have been illustrated and described, numerous modifications come to mind without significantly departing from the spirit of the invention and the scope of protection is only limited by the scope of the accompanying claims.

What is claimed is:

1. A system for filling seeds into a container, the system comprising:
a bulk seed hopper containing a plurality of seeds;
an RFID tag hopper containing a plurality of RFID tags having a seed-like shape;
a singulator configured to separate an individual RFID tag of the plurality of RFID tags from the RFID tag hopper;
an RFID tag reader configured to read a factory setting from the individual RFID tag;
an RFID tag writer configured to encode a predetermined set of data on the individual RFID tag; and
wherein a portion of the plurality of seeds are dispensed from the bulk seed hopper into the container, and
wherein the individual RFID tag is dispensed into the container.

2. The system of claim 1, wherein a processor determines if the individual RFID tag is operational based off information from the RFID tag reader reading of the factory setting.

3. The system of claim 2, wherein static data presented in the factory setting of the individual RFID tag is associated with an internal Batch ID number is be used for internal tracking of which seed batch was planted in a read location.

4. The system of claim 2, wherein when the processor determines the individual RFID tag is inoperative, the individual RFID tag is discarded.

5. The system of claim 1, wherein the singulator includes a servo motor, a vacuum, and a seed plate.

6. The system of claim 1, wherein the singulator includes a vibratory feeder and a staging system.

7. The system of claim 1, further comprising a drop gate that holds the individual RFID tag after the predetermined set of data is written to the individual RFID tag.

8. The system of claim 7, wherein a processor sends a signal to the drop gate to dispense the individual RFID tag into the container.

9. The system of claim 1, wherein the predetermined set of data includes a product name of the seeds filled in the container.

10. The system of claim 9, wherein static data presented in the factory setting of the individual RFID tag is associated with an internal Batch ID number that is different than the product name.

11. The system of claim 1, wherein the system further provides a planting mechanism that plants the individual RFID tag and a second RFID tag reader thereby detecting and recording an identity of the container of seeds being planted in that location.

12. The system of claim 1, wherein the plurality of RFID tags comprises a material that is decomposable.

13. A machine for dispensing seed-like shaped RFID tags comprising:
an RFID tag hopper configured to store a plurality of RFID tags, wherein each RFID tag of the plurality of RFID tags has a seed-like shape;
a singulator connected to the RFID tag hopper, wherein the singulator separates an individual RFID tag of the plurality of RFID tags from the RFID tag hopper;
an encoding chamber connected to the singulator, wherein an RFID tag reader reads a factory setting from the individual RFID tag and an RFID tag writer encodes a predetermined set of data to the individual RFID tag; and
a drop gate connected to the encoding chamber to hold the individual RFID tag until instructed by a processor to open the drop gate and release the individual RFID tag into a container of seeds.

14. The machine of claim 13, further comprising a discard chute located after the encoding chamber.

15. The machine of claim 13, further including a non-transitory computer readable medium storing computer readable instructions that, when executed by the processor, causes the processor to at least:
receive a user input for the predetermined set of data; and
instruct the RFID tag writer to encode the predetermined set of data to the individual RFID tag.

16. The machine of claim 13, further including a non-transitory computer readable medium storing computer readable instructions that, when executed by the processor, causes the processor to at least:
instruct the drop gate to dispense the individual RFID tag into the container; and
determine a time interval or volumetric or weight based bulk dispensing to open and close the drop gate to control a number of RFID tags dispensed into the container of seeds.

17. The machine of claim 13, wherein the RFID tag hopper is positioned above the singulator and the drop gate.

18. The machine of claim 13, wherein the singulator includes a vibratory feeder and a staging system.

19. The machine of claim 13, wherein the singulator includes a vacuum and a servo motor, along with a seed plate to individually select the individual RFID tag.

20. A method for dispensing seed-shaped RFID tags comprising:
loading a plurality of seed-shaped RFID tags into an RFID tag hopper;
extracting an individual RFID tag from the RFID tag hopper;
verifying the extracted individual RFID tag is operational;
discarding the extracted individual RFID tag if it is inoperable;
encoding a predetermined set of data onto the extracted individual RFID tag;
moving the extracted individual RFID tag to a drop gate; and
opening the drop gate to dispense the extracted individual RFID tag into a container of seeds.

21. The method of claim 20, wherein the predetermined set of data includes a product name of the seeds inserted into the container.

22. The method of claim 21, wherein static data presented in a factory setting of the individual RFID tag is associated with an internal Batch ID number that is different than the product name.

23. The method of claim 20, wherein the method further comprises using on a planting mechanism that plants the individual RFID tag and a second RFID tag reader to detect and record an identity of the container of seeds being planted in that location.

24. The method of claim 23, wherein an antenna of the second RFID tag reader is located in a position on the planting mechanism that reads the individual RFID tag at a point where the individual RFID tag is located in a portion of the planting mechanism where the seeds aggregate prior to being singulated for planting.

25. The method of claim 23, wherein the predetermined set of data read from the individual RFID tag is transmitted directly to an ISOBUS of the planting mechanism.
